(19) United States
(12) Patent Application Publication
(10) Pub. No.: US 2016/0151926 A1
(43) Pub. Date: Jun. 2, 2016

(54) Operating element of powder gas actuated tools

(71) Applicant: Przemyslowy Instytut Automatyki I Pomiarow PIAP, Warszawa (PL)

(72) Inventors: Mariusz ZBOINSKI, Warszawa (PL); Piotr Kociel, Serokomla (PL)

(73) Assignee: PRZEMYSLOWY INSTYTUT AUTOMATYKI I POMIAROW PIAP, Warszawa (PL)

(21) Appl. No.: 14/438,610

(22) PCT Filed: Mar. 31, 2014
(86) PCT No.: PCT/PL2014/000030

§ 371 Date: Apr. 24, 2015

(51) Int. Cl. B26D 5/12; B26D 7/26; B25D 17/24; B25D 9/00

(52) U.S. Cl. CPC B26D 5/12; B25D 9/00; B26D 7/2614; B25D 17/24; B26D 2007/2685

(57) ABSTRACT

Operating element of powder gas actuated took and equipped with a combustion chamber, wherein the element is of a cylindrical shape, and in the internal chamber of the cylindrical body (1), there is a displaced piston (2) located and equipped with the arbour (3) surrounded by a return spring element (4); however, the arbour (3) is terminated with a replaceable operating bit (5), and the return spring element (4) is supported with one end of the piston (2) and with the other on the bottom (6) of the cylindrical body (1), which has a port hole, in which the arbour (3) is guided.

The invention relates to an operating element of powder gas actuated tools and equipped with combustion chamber; the element is of a cylindrical shape. The operating element, according to the invention, can be, among other things, installed on hand tools and mobile robots.

Patent application PL 191742 is known in the art, which discloses a setting tool having a guide cylinder displaceable relative to the tool housing, in which there is an axially guided drive piston. There is a control pin projecting from the guide cylinder in a direction opposite to the setting, which when pressing the setting tool against the base, together with the guide cylinder, is moved to a direction opposite to the setting. Because of the proper mating surface on an inert firing pin, with which the control pin cooperates, the firing pin is displaced to a position ready to fire. This solution relates to a setting tool actuated by a powder. The solution is related to drive pin-type fixing elements to hard bases, such as stone, concrete, steel or the like.

The solution disclosed in U.S. Pat. No. 7,117,779 (B1) applies to a drive for energy supplied tools. The application relates to driven tools and methods of supplying energy/power to the driven tools. In the disclosed application, the source of energy/power supplying the energy/power to drive the mechanical tools comprises a receiving, chamber with discrete propellant charge. In some cases of detonation, the gases are generated, in other cases of detonation, expansion takes place in the receiving chamber; however, the receiving chamber includes a reactive closure which dynamically responds to pressure changes in the receiving chamber and wherein said supply/power source further includes a linkage associated with the reactive closure for transmitting energy from the dynamic response of the reactive closure to the mechanical device.

The application AU2004202298 (A1) presents a method of overlocking at least one strand in an anchoring block and the system of overlocking at least one strand in an anchoring block. The process consists in driving a counterbalance using a charge explosion.

The application DE19804820 (A1) discloses a charge penetrating screens with extraction device. The device is used, for example, to penetrate screens such as a window. A projectile is fired from a capitive bolt gun, the muzzle is in contact with a window.

The device disclosed in the application U.S. Pat. No. 6,125,055 (A) relates to an explosive powder charge-operated setting tool including a guide cylinder displaceable relative to the tool housing, a drive piston displaceably arranged in the inner bore of the guide cylinder, a control pin projecting from the guide cylinder in a direction opposite to a setting direction, a spring-biased firing pin cooperating with the control pin, which releases a pusher for displacing the mating surface of the firing pin out of an axial projection surface of the control pin, a trigger for actuating the release pusher and a back-up pin projecting into the inner bore of the guide cylinder with the smallest distance between the back-up pin, and a bit installed inside, facing in the direction of the length of the drive piston.

The purpose of the invention is to develop an operating element of powder gas actuated tools equipped with interchangeable bits, applied in connection with small sized mobile robots.

The operating element of powder gas actuated tools and equipped with a combustion chamber, wherein the element has a cylindrical body, characterised in that inside the chamber of the cylindrical body (1) there is a displaced piston (2) located, equipped with an arbour (3) surrounded by an flexible element (4). The arbour (3) is terminated with the interchangeable operating bit (5), and the flexible element (4) is supported with one end on the piston (2) and with the other on the bottom (6) of the cylindrical body (1), which has a port hole, inside of which the arbour (3) is guided.

Preferably, the port hole in the bottom (6) is extended outside by the sleeve (7), which is a guide for the interchangeable operating bit (5).

Preferably, the flexible element (4) is a shock-absorber made of an elastomer of cellular structure, elastomer springs or other springs.

Preferably, the piston (2) is equipped with guide rings (8).

Preferably, the interchangeable operating bit (5) is of cylindrical shape.

Preferably, the interchangeable operating bit (5) is of a conical shape.

Preferably, the interchangeable operating bit (5) is of a cylindrical shape, terminated with a cutting edge in the shape of a cone; however, at least two indents are located on the side of the cylinder, in which spring-folded and unfolded arms (9) are located.

Preferably, the interchangeable operating bit (5) is a point chisel, the cutting edge of which comprises four walls in the shape of right-angled triangles, having one common leg, which at the same time is a symmetry axis of the interchangeable operating bit (5).

Preferably, the interchangeable operating bit (5) is a multi-sloped cutting edge in the shape of a truncated cone and a cone located on it; however, the inclination angle of the cone wall is less than the inclination angle of the truncated cone. More preferably, parallel recesses (10) are made on the truncated cone that runs along the wall.

Preferably, the interchangeable operating bit (5) is a cutting edge in the shape of a diagonally cut cylinder with recessed interior.

Preferably, on the bottom (6), from its external side, there are two longitudinal elements (11) symmetrically located in relation to the piston (2) displacement axis and perpendicularly to the bottom (6) surface, and which are equipped on the opposite surfaces with guides (12) for the interchangeable operating bit (5) in the shape of a cutting edge, the operating edge of which is faced towards the free longitudinal ends of the elements (11).

Preferably, the interchangeable operating bit (5) is in the shape of a cutting edge, and the bottom (6) is equipped with a holder (13); however, the angular position of the cutting edge of the interchangeable operating bit (5) is determined by a limiter (14) which is installed in the holder (13) using the first screw (15); moreover, the holder (13) is equipped with the cutter (17), installed using the second screw (16); additionally, a thrust washer (18) is installed between the flexible element (4) and the interchangeable operating bit (5).

The invention is presented in the embodiment in the drawing, in which

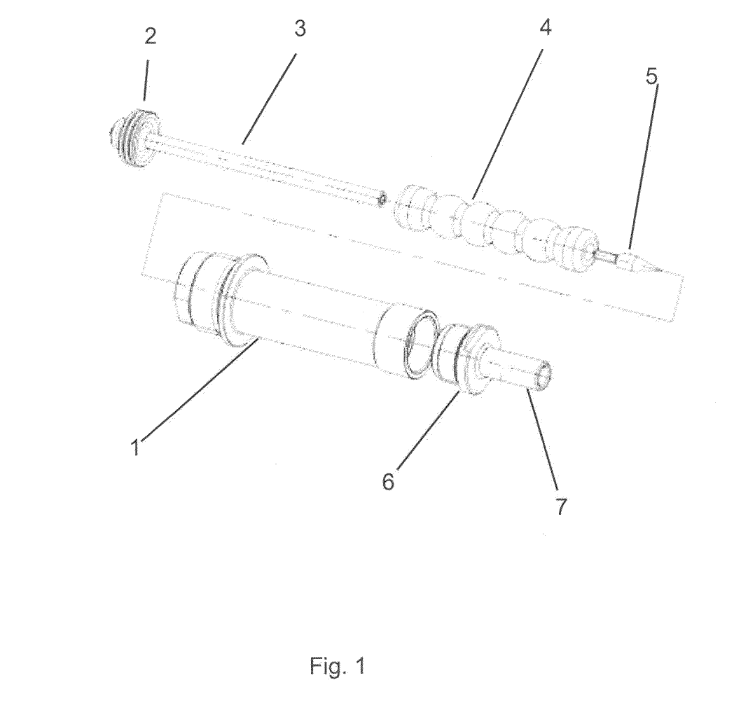

FIG. 1 presents the first embodiment of the operating element,

FIG. 2 the second embodiment of the operating element,

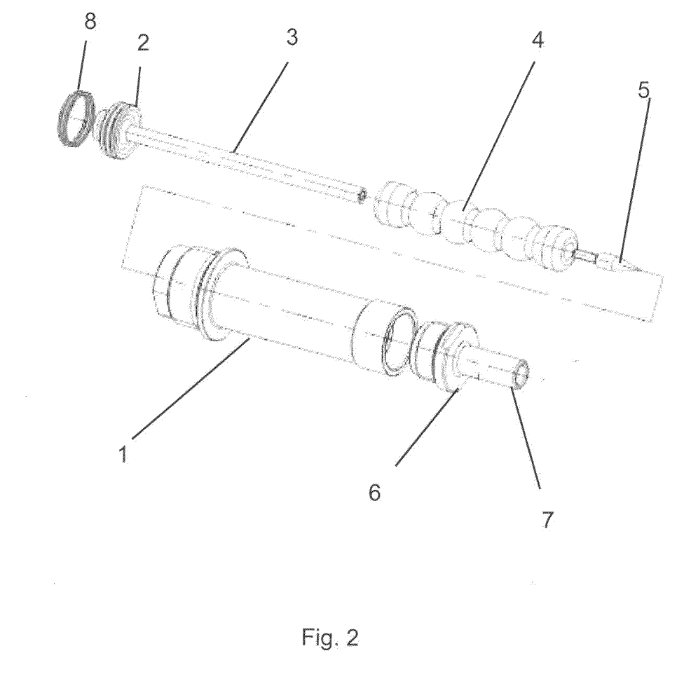

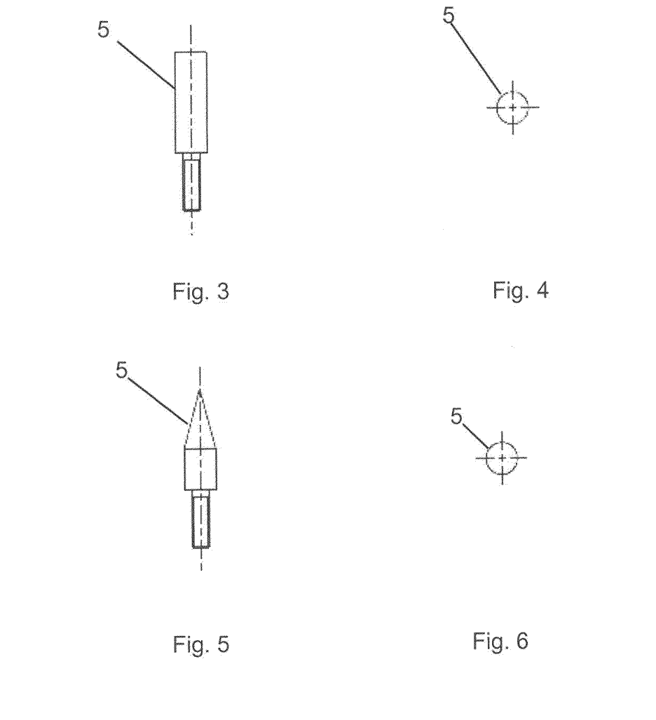

FIG. 3-16 embodiments of interchangeable operating bits,

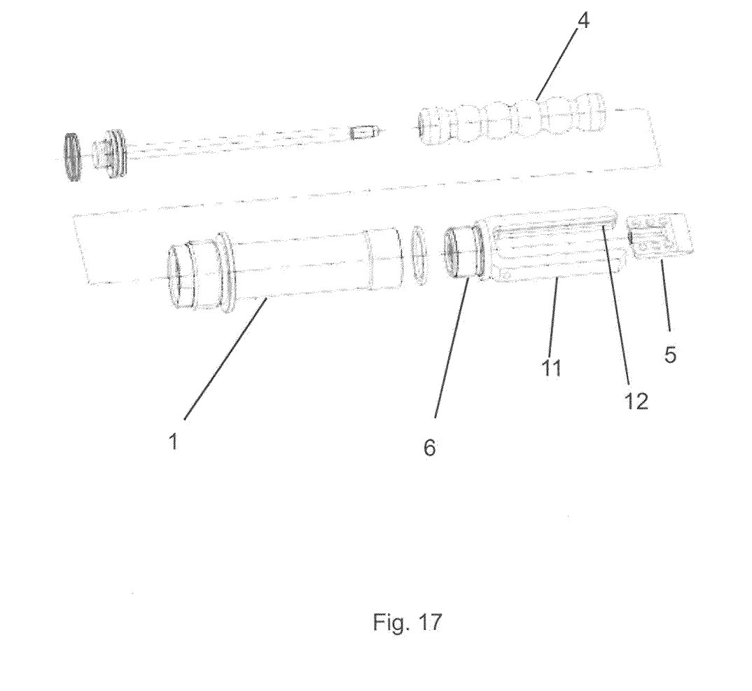

FIG. 17 the third embodiment of the operating element,

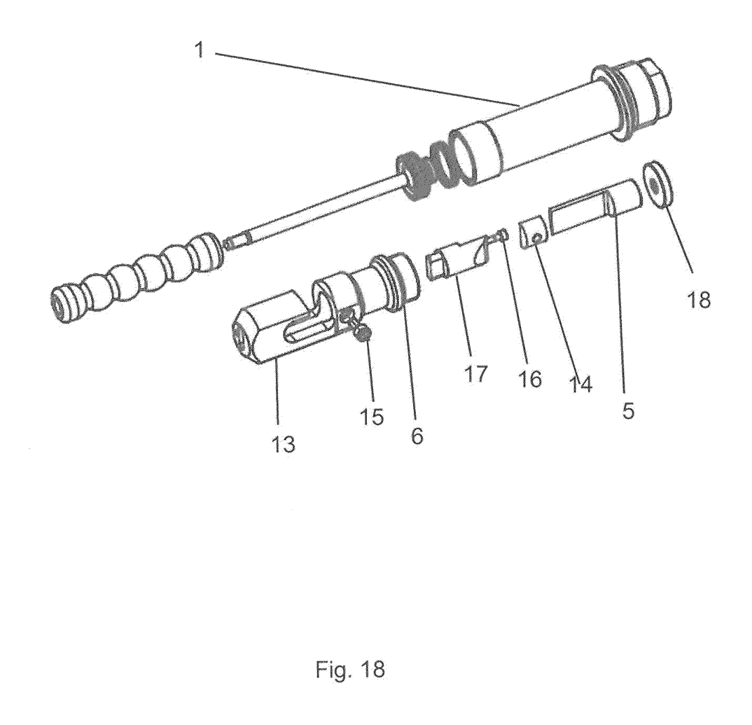

FIG. 18 the fourth embodiment of the operating element.

FIG. 1 presents the first embodiment of the operating element according to the invention. The operating element has a cylindrical body, in the internal chamber of which there is a displaceable piston (2) located and equipped with the arbour (3) surrounded by the flexible element (4). The flexible element (4) is a shock-absorber in the form of elastomer of cellular structure (a springs may also be used). The arbour (3) is terminated with the interchangeable operating bit (5). The interchangeable operating bit (5) is fixed on the arbour (3) using a thread. It can also be detachably, slidably or snap installed. The flexible element (4) is supported with one end on the piston (2) and with other on the bottom (6) of the cylindrical body (1), which has a port hole, inside of which the arbour (3) is guided. Moreover, the port hole in the bottom (6) is extended outside by the sleeve (7), which is a guide for the interchangeable operating bit (5). This, however, is not an essential element for the functioning of the operating element. The operating element connects with the combustion chamber of the powder gas actuated tool. Powder gas provides energy to the piston (2) until the moment just before hitting an object. The piston (2) moves with kinetic energy, and the operating bit (5) located on its arbour (3) hits the object. If the object is penetrated and the piston (2) moves further, then it is stopped by the flexible element (4), and then the flexible element (4) moves the piston back to the initial position.

In the second embodiment presented in the FIG. 2, the piston (2) is equipped with guide rings (8) to reduce piston (2) friction.

FIGS. 3 and 4 present an interchangeable operating bit (5) in the shape of a cylinder. This operating bit is used, though not only, to drive elements, e.g. locks to doors.

FIGS. 5 and 6 present an interchangeable operating bit (5) in the shape of a cone. The bit is used to break or puncture glass panes or other materials. The shape of the cutting edge causes that the puncturing takes place using a cutting edge end, and its further part facilitates insertion into the material.

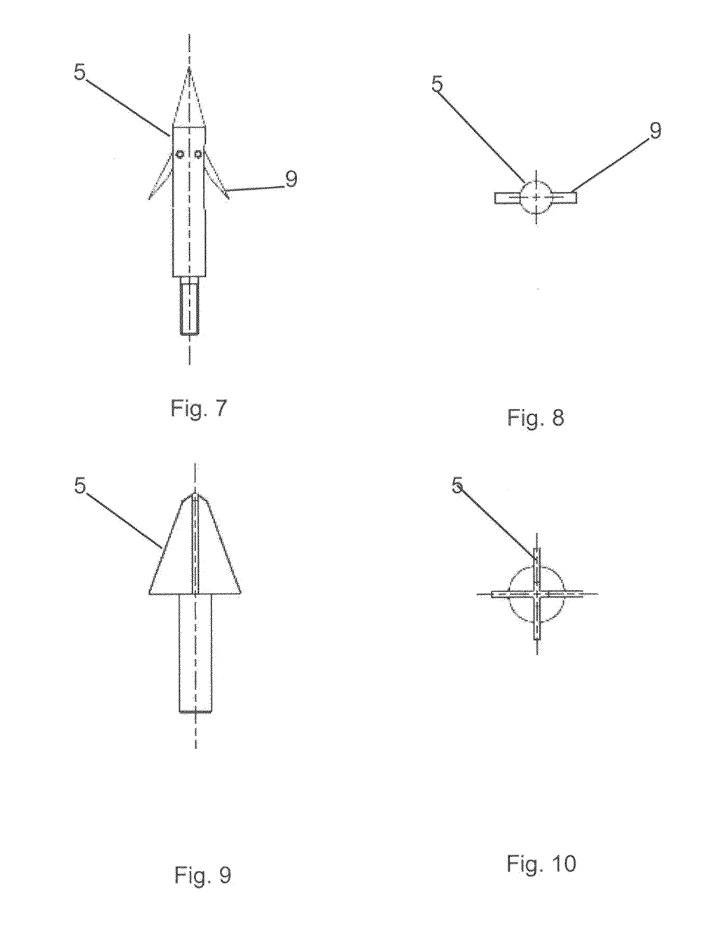

FIGS. 7 and 8 present an interchangeable operating bit (5) of cylindrical shape terminated with a cutting edge in the shape of a cone; however, at least two indents are located on the side of the cylinder, in which spring-folded and unfolded arms (9) are located. Such a bit represents a point chisel, which is used to drive into material, e.g. sheet metal. After puncturing the material layer, the point chisel unfolds by spring force, and this prevents its removal.

FIGS. 9 and 10 present an interchangeable operating bit (5) in the shape of a point chisel, the cutting edge of which comprises four walls in the shape of right-angled triangles, having one common leg, which at the same time is a symmetry axis of the interchangeable operating bit (5). The point chisel is used to drive into materials such as sheet metal. Similarly to the previous embodiment, the point chisel can be connected to a line or chain used to pull/tow and fixing shackles or eyes.

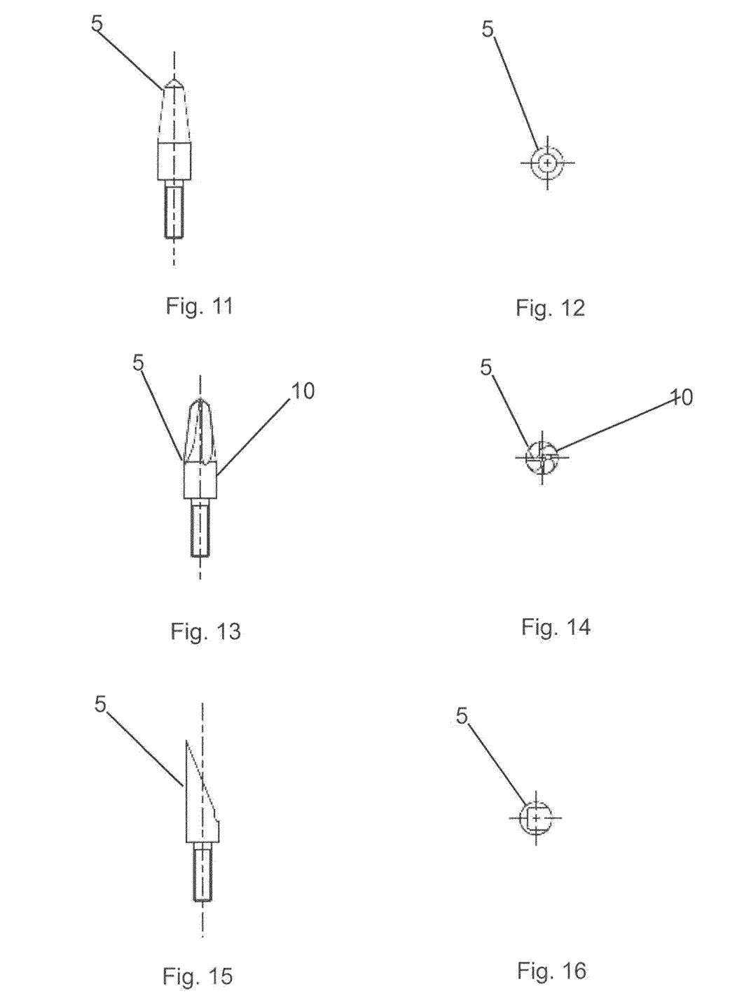

FIGS. 11 and 12 present an interchangeable operating bit (5) in the shape of a multi-sloped cutting edge in the shape of truncated cone and with a cone located on it; however, the inclination angle of the cone wall is less than the inclination angle of the truncated cone. The bit can be used to puncture glass panes or other materials. The shape of the cutting edge causes that the puncturing takes place using the cutting edge end, and its further part facilitates insertion into the material.

FIGS. 13 and 14 present an interchangeable operating bit (5) in the shape of a multi-sloped cutting edge in the shape of a truncated cone and with a cone located on it; however, the inclination angle of the cone wall is less than the inclination angle of the truncated cone; however, parallel recesses (10) run along the wall of the truncated cone. The recesses facilitate insertion into the material.

FIGS. 15 and 16 present an interchangeable operating bit (5) with a cutting edge in the shape of a diagonally cut cylinder, the interior of which is recessed. The bit is, though not only, used to puncture tyres.

FIG. 17 presents the operating element, wherein on the bottom (6), from its external side, there are two longitudinal elements (11) symmetrically located in relation to the piston (2) displacement axis and perpendicularly to the bottom (6) surface, and which are equipped on opposite surfaces with guides (12) for the interchangeable operating bit (5) in the shape of a cutting edge, the working edge of which is faced towards the free longitudinal ends of the elements (11). Such construction of the operating element allows for it to be used, though not only, to truncate or cut longitudinal elements such as bars, cables.

FIG. 18 presents the operating element, wherein the interchangeable operating bit (5) is in the shape of a cutting edge, and the bottom (6) is equipped with a holder (13); however, the angular position of the cutting edge of the interchangeable operating bit (5) is determined by a limiter (14) that is installed in the holder (13) using the first screw (15); moreover, the holder (13) is equipped with the cutter (17) installed using the second screw (15); additionally, a thrust washer (18) is installed between the return spring element (4) and the interchangeable operating bit (5). Such operating element is used to cut longitudinal elements such as bars, cables.

To provide performance and operation characteristics, the operating elements are subject to detailed post-production inspection. Due to safety reasons, it is important that all elements in contact with expanding powder gases are free from any defects, micro-defects so that they are in conformity with the technical documentation. Metal elements were subject to thermal working (quenching/hardening), roughing, finishing and coated with a protective coating. Elements in direct or indirect contact with powder gases are coated with TENIFER technology coating. This technology guarantees a high level of safety against mechanical, environmental and thermal-chemical factors accompanying the combustion of powder gases. Moreover, this is a coating method on the so-called ready-made detail, which does not require finishing after coat application. All elements that cooperate slidably were ground or honed, adhering to the principles of the reference positioning of elements, in order to provide the best possible cooperation with the lowest possible friction. The elements are manufactured according to rigorous geometrical tolerances concerning radial run-out and circularity.

Steel used to manufacture weapons was used to make the elements of the body (1), piston (2) and combustion chamber. To manufacture interchangeable operating bits (5), tool steel subjected to a hardening and tempering process was used in order to obtain maximum strength during operation.

The interchangeable operating bits (5) presented in the embodiments in FIGS. 3-14 were subjected to a test consisting in puncturing various materials, including: glass panes, wooden boards, aluminium sheets, sheet steel and laminates. The interchangeable operating bits (5) presented in FIGS. 15 and 16 were subjected to a test consisting in puncturing tires. The operating elements presented in FIGS. 17 and 18 were subjected to a test consisting in cutting electrical cables, chains and bars of different materials and of different diameters. Each of the tested elements performed a cycle of 100 shots and returns under normal conditions. During and after the tests, excessive indications of wear did not appear. In connection to the controlled designing process, this allows for the assumption that the elements meet the performance and operational requirements put before such solutions.

1. An operating element of powder gas actuated tools and equipped with a combustion chamber, wherein the element is of cylindrical body, characterised in that in the internal chamber of the cylindrical body (1), there is a displaced piston (2) located and equipped with an arbour (3) surrounded by a flexible element (4); however, the arbour (3) is terminated with a replaceable operating bit (5), and the flexible element (4) is supported with one end of the piston (2) and with the other on the bottom (6) of the cylindrical body (1), which has a port hole, in which the arbour (3) is guided.

2. The element, according to claim 1, wherein the port hole in the bottom (6) is extended outside by the sleeve (7), which is a guide for the interchangeable operating bit (5).

3. The element, according to claim 1, wherein the flexible element (4) is a shock-absorber made of an elastomer of cellular structure, elastomer springs or other springs.

4. The element, according to claim 1, wherein the piston (2) is equipped with guide rings (8).

5. The element, according to claim 1, wherein the interchangeable operating bit (5) is in the shape of a cylinder.

6. The element, according to claim 1, wherein the interchangeable operating bit (5) is in the shape of a cone.

7. The element, according to claim 1, wherein the interchangeable operating bit (5) is of a cylindrical shape terminated with a cutting edge in the shape of a cone; however, at least two indents are located on the side of the cylinder, in which spring-folded and unfolded arms (9) are located.

8. The element, according to claim 1, wherein the interchangeable operating bit (5) is a point chisel, the cutting edge of which comprises four walls in the shape of right-angled triangles, having one common leg, which at the same time is a symmetry axis of the interchangeable operating bit (5).

9. The element, according to claim 1, wherein the interchangeable operating bit (5) is a multi-sloped cutting edge in the shape of a truncated cone with a cone located on it; however, the inclination angle of the cone wall is less than the inclination angle of the truncated cone.

10. The element, according to claim 9, wherein parallel recesses (10) are made on the truncated cone that run along the wall.

11. The element, according to claim 1, wherein the interchangeable operating bit (5) is a cutting edge in the shape of a diagonally cut cylinder with a recessed interior.

12. The element, according to claim 1, wherein on the bottom (6), from its external side, there are two longitudinal elements (11) symmetrically located in relation to the piston (2) displacement axis and perpendicularly to the bottom (6) surface, and which are equipped on opposite surfaces with guides (12) for the interchangeable operating bit (5) in the shape of a cutting edge, the working edge of which is faced towards the free longitudinal ends of the elements (11).

13. The element, according to claim 1, wherein the interchangeable operating bit (5) is in the shape of a cutting edge, and the bottom (6) is equipped with a holder (13); however, the angular position of the cutting edge of the interchangeable operating bit (5) is determined by a limiter (14) which is installed in the holder (13) using the first screw (15); moreover, the holder (13) is equipped with the cutter (17) installed using the second screw (16); additionally, a thrust washer (18) is installed between the flexible element (4) and the interchangeable operating bit (5).
